(19) United States
(12) Patent Application Publication
(10) Pub. No.: US 2018/0084944 A1
(43) Pub. Date: Mar. 29, 2018

(54) COOKING GRATE WITH ADJUSTABLE HEATING CHARACTERISTICS

(71) Applicant: W.C. BRADLEY CO., Columbus, GA (US)

(72) Inventor: MALLIK AHMED, Columbus, GA (US)

(21) Appl. No.: 15/718,225

(22) Filed: Sep. 28, 2017

Related U.S. Application Data
(60) Provisional application No. 62/401,543, filed on Sep. 29, 2016.

(51) Int. Cl. A47J 37/06; A47J 27/00

(52) U.S. Cl. CPC A47J 37/0694; A47J 27/002

(57) ABSTRACT

A cooking grate having a first upper sub-grate with a first plurality of cooking members retained in a fixed relationship relative to one another by at least one upper cross-member, and a second lower sub-grate with a second plurality of cooking members retained in a fixed relationship relative to one another by at least one lower cross member. The first and second sub-grate fit together such that only an indirect path remains from below the cooking surface to above the cooking surface such that flame is impeded from travelling below the cooking surface to above the cooking surface.

### CROSS-REFERENCE TO RELATED CASES

This application claims the benefit of U.S. provisional patent application Ser. No. 62/401,543, filed on Sep. 29, 2016, and incorporates such provisional application by reference into this disclosure as if fully set out at this point.

### FIELD OF THE INVENTION

This application relates to food preparation in general and, more particularly, to cooking using a grate placed over a heat source.

### BACKGROUND OF THE INVENTION

Cooking with gas and charcoal grills may be done with a combination of convective heat, from hot gases of combustion, and radiant heat, from surfaces heated by such gases in various ways. Cooking with predominately radiant heat (e.g., in excess of 50% or 60% or 70% of the total heat available) at a plane just below or just above the food support element can have benefits with many types of food and cooking styles. However, it is also true that some types of cooking, for example slow cooking with exposure to smoke, may be preferred with less radiant heat than 50%, 60%, or 70%. Previously, products were designed and manufactured without consideration of allowing a user to alter the ratio of convective to radiative heat on the same cooking device.

What is needed is a system and method for addressing the above, and related, issues.

### SUMMARY OF THE INVENTION

The invention of the present disclosure, in one aspect thereof, comprises a cooking grate having a first upper sub-grate with a first plurality of cooking members retained in a fixed relationship relative to one another by at least one upper cross-member, and a second lower sub-grate with a second plurality of cooking members retained in a fixed relationship relative to one another by at least one lower cross member. The first and second sub-grates are configured to fit together such that their respective cooking members interfit to define a first cooking surface that heats with a relatively high degree of radiant heating relative to convective heating. The first and second sub-grate each define a second cooking surface that heats with a relatively low degree of radiant heating relative to convective heating. The first and second sub-grate fit together such that only an indirect path remains from below the cooking surface to above the cooking surface such that flame is impeded from travelling below the cooking surface to above the cooking surface.

In some embodiments, the cooking members of the first and second sub-grates have an inverted V shape with vertices of the cooking members of the first and second sub-grates terminating and substantially the same level. The cooking members of one of the first and second sub-grates may have legs that extend to terminate below the legs of cooking members of the other sub-grate. The cooking members of the first and second sub-grate may overlap laterally.

In some embodiments, the first sub-grate retains its associated cooking members at a first predetermined spacing from one another. The second sub-grate may retain its associated cooking members at a second predetermined spacing from one another. The first and second predetermined spacings may be different so as to provide different degrees of heating between radiant and convective heating.

The invention of the present disclosure, in another aspect thereof, comprises a cooking grate with two integrated sub-grates each having two end cross members maintaining a plurality of cooking members in a fixed relationship with respect to one another. The cross members on at least one end of each of the respective sub-grates nest to prevent end to end movement between the sub-grates. The cooking members of one sub-grate interleaved with the cooking members of the other sub-grate form a cooking surface operable to prevent contact between a cooking flame coming from below the cooking surface to food resting atop the cooking surface by blocking any straight vertical path through the cooking surface.

The plurality of cooking members of each of the sub-grates may comprise inverted V shapes with apices terminating at the same level to form the cooking surface. In some embodiments, one of the sub-grates forms an upper sub-grate and the other sub-grate forms a lower sub-grate. The cooking members of the lower sub-grate may have legs that extend down from the apices below a level of legs extending from the apices of the cooking members of the upper sub-grate. The legs of the upper and lower sub-grate may overlap laterally.

Each sub-grate may have two cross members with one affixed at opposite ends of the plurality of cooking members. Each sub-grate may form a separate cooking surface that may be used alone and each separate cooking surface may provide a relatively higher degree of convective cooking energy than the cooking surface formed by the combined sub-grates. Each sub-grate may also have a different lateral spacing between adjacent cooking members thereof than the other sub-grate.

The invention of the present disclosure, in another aspect thereof, comprises a cooking grate having a first sub-grate formed from a first plurality of parallel cooking members held in a fixed relationship by a first cross member, and a second sub-grate formed from a second plurality of parallel cooking members held in a fixed relationship by a second cross member. The first and second sub-grates combine to form a cooking surface that prevents flame from travelling therethrough to food on the cooking surface by blocking vertical pathways therethrough.

The parallel cooking members of the first sub-grate may have a lateral overlap with cooking members of the second sub-grate. The cooking members of the first and/or second sub-grate may have an inverted V shape. The cooking grate of claim 16, wherein the cooking members of the first sub-grate and the cooking members of the second sub-grate have may have apices at the same level, but the cooking members of the second sub-grate have lower spaced apart legs that extend below lower spaced apart legs of the first sub-grate.

In some embodiments, the first and second cross members removably nest to prevent lengthwise movement between the first and second plurality of cooking members. The first and second sub-grates may each be used as a separate cooking surface that provides a pathway for flame from below to contact food on the separate cooking surfaces. Each of the first and second sub-grates may have an additional cross member with the two cross members of each of the first and second-sub grates forming end caps to the respective parallel cooking members.

### BRIEF DESCRIPTION OF THE DRAWINGS

FIG. 1 is a perspective view of a formed multi-part cooking grate according to aspects of the present disclosure.

FIG. 2 is a perspective side cutaway view of a portion of the cooking grate of FIG. 1.

FIG. 3 is a perspective end cutaway view of the cooking grate of FIG. 1.

FIG. 4 is a close-up end cutaway view of a portion of the cooking grate of FIG. 1.

FIG. 5 is a perspective view of an upper portion of the cooking grate of FIG. 1.

FIG. 6 is a perspective side cutaway view of a portion of the upper cooking grate of FIG. 5.

FIG. 7 is a perspective end cutaway view of the upper grate of FIG. 5.

FIG. 8 is a close-up end cutaway view of a portion of the grate of FIG. 5.

FIG. 9 is a perspective view of a lower cooking grate of FIG. 1.

FIG. 10 is a perspective side cutaway view of a portion of the lower cooking grate of FIG. 9.

FIG. 11 is a perspective end cutaway view of the lower cooking grate of FIG. 9.

FIG. 12 is a close-up end cutaway view of a portion of the lower cooking grate of FIG. 9.

FIG. 13 is a perspective view of another embodiment of a cast or forged multi-part cooking grate according to aspects of the present disclosure.

FIG. 14 is a perspective cutaway view of a portion of the cooking grate of FIG. 13.

FIG. 15 is a close-up end cutaway view of a portion of the cooking grate of FIG. 13.

FIG. 16 is a perspective view of an upper portion of the multi-part cooking grate of FIG. 13.

FIG. 17 is a perspective cutaway view of a portion of the upper cooking grate of FIG. 16.

FIG. 18 is a close-up end cutaway view of a portion of the upper cooking grate of FIG. 16.

FIG. 19 is a perspective view of a lower portion of the multi-part cooking grate of FIG. 13.

FIG. 20 is a perspective cutaway view of a portion of the lower cooking grate of FIG. 19.

FIG. 21 is a close-up end cutaway view of a portion of the lower cooking grate of FIG. 19.

FIG. 22A is a plot of corrected total heat flux for a cooking grate according to the present disclosure on a front location.

FIG. 22B is a plot of corrected total heat flux for the same cooking grate on a center location.

FIG. 22C is a plot of corrected total heat flux for the same cooking grate on a back location.

FIG. 23A is a plot of corrected total heat flux for another cooking grate according to the present disclosure on a front location.

FIG. 23B is a plot of corrected total heat flux for the same cooking grate on a center location.

FIG. 23C is a plot of corrected total heat flux for the same cooking grate on a back location.

FIG. 24 is an end-on cutaway view of a cooking grate with variable spacing between sub-grates according to the present disclosure.

FIG. 25 is a perspective view of another embodiment of multi-part cooking grate according to aspects of the present disclosure.

FIG. 26 is an exploded perspective view of the multi-part cooking grate of FIG. 25 illustrating separated upper and lower cooking grates.

FIG. 27 is a perspective side cutaway view of a portion of the upper cooking grate of FIG. 26.

FIG. 28 is a perspective cutaway view of a portion of the lower cooking grate of FIG. 26.

FIG. 29 is a cutaway perspective view of the multi-part cooking grate of FIG. 25.

FIG. 30 is a cutaway end view of the multi-part cooking grate of FIG. 25.

FIG. 31 is a close up cutaway end view of the multi-part cooking grate of FIG. 25.

### DETAILED DESCRIPTION OF THE PREFERRED EMBODIMENTS

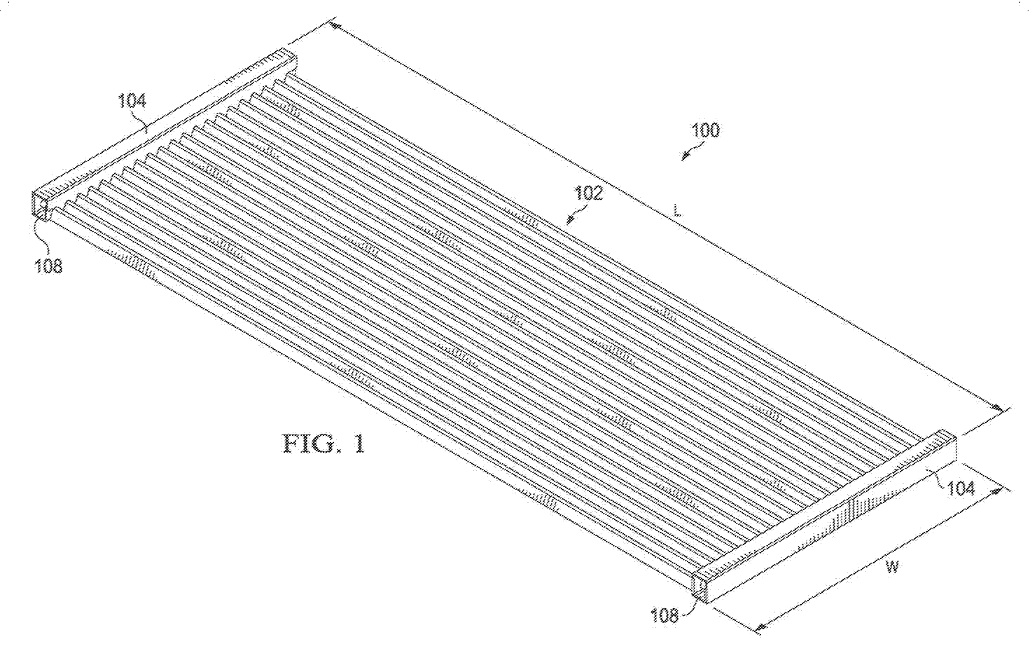

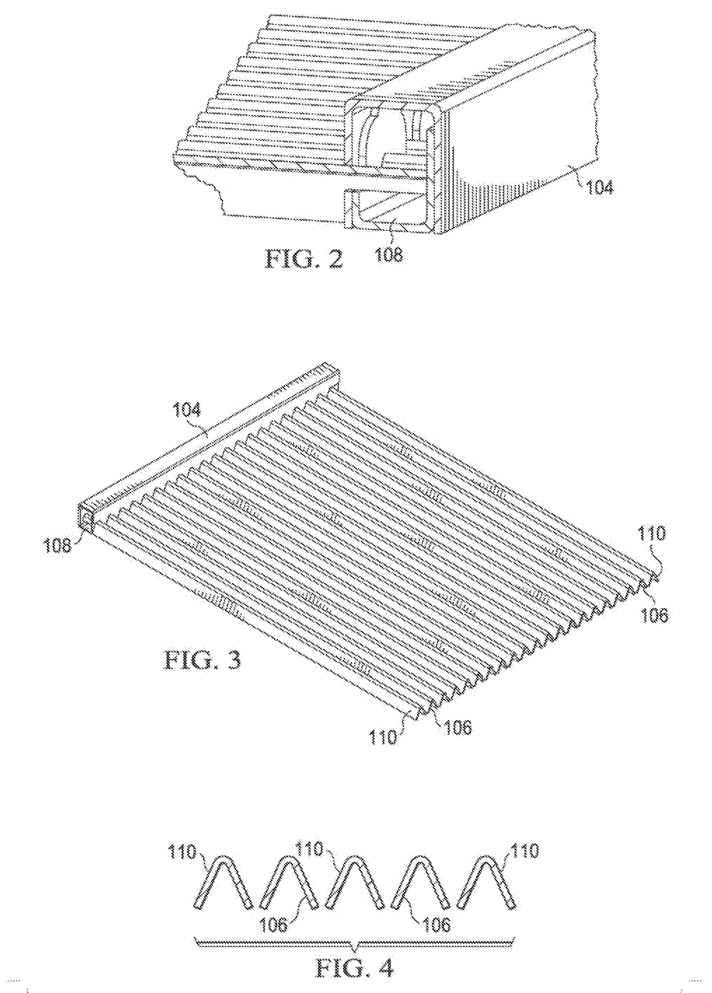

Referring now to FIGS. 1-12, one embodiment of a multi-part cooking grate in accordance with the present disclosure will be described. FIG. 1 is a perspective view of a formed multi-part cooking grate according to aspects of the present disclosure. In the present embodiment, an arrangement of food support elements in a general form of inverted V-shapes are utilized (though other cross sectional shapes can also be used) to form a cooking surface 102. FIG. 2 is a perspective side cutaway view of a portion of the cooking grate 100 of FIG. 1. FIG. 2 illustrates the interlocking and constructing of cross members 104, 108 discussed further below. FIG. 3 is a perspective end cutaway view of the cooking grate of FIG. 1 illustrating the inverted V-shape of the grill surface 102.

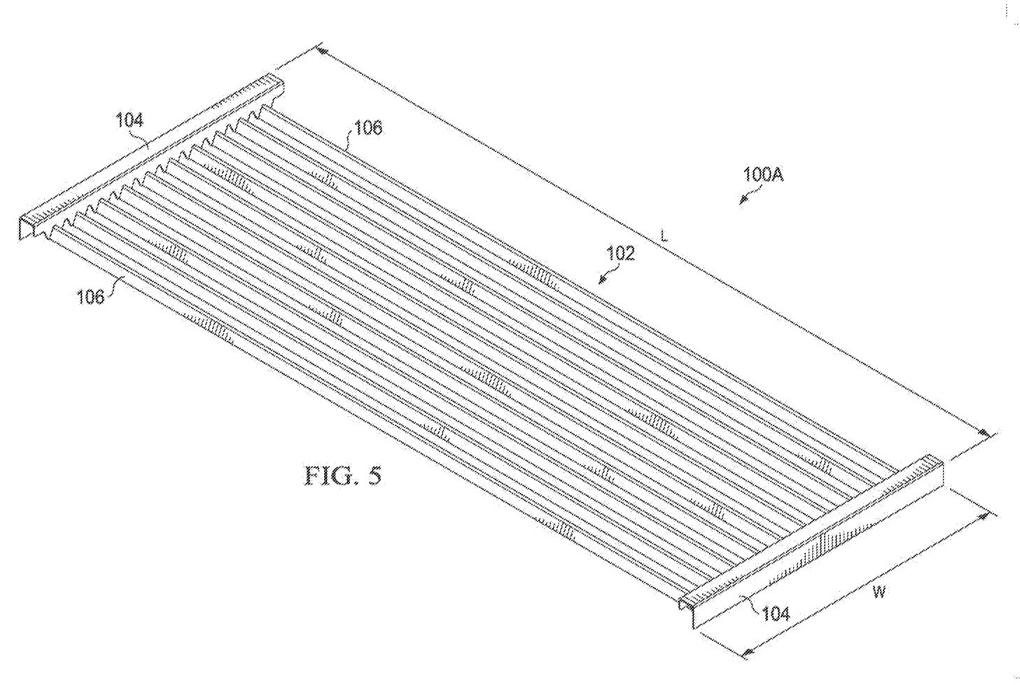

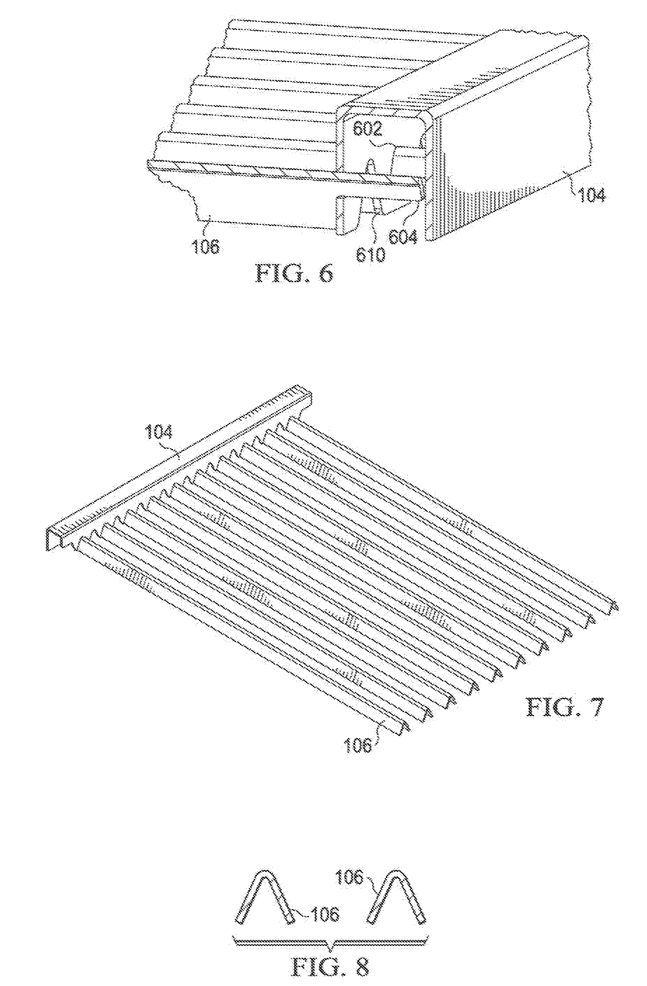

FIG. 4 is a close-up end cutaway view of a portion of the cooking grate 100 of FIG. 1 illustrating that the surface 102 comprises two set sets 106, 110 of V-shaped cooking members. Referring now to FIG. 5, a perspective view of an upper portion 100A of the cooking grate of FIG. 1 is shown. The upper portion 100A includes cross members 104 retaining cooking members 106 in a fixed and inverted relationship with respect to one another and forms a portion of the cooking surface 102. FIG. 6 is a perspective side cutaway view of a portion of the upper cooking grate 100A of FIG. 5. FIG. 7 is a perspective end cutaway view of the upper grate 100A of FIG. 5. Finally, FIG. 8 is a close-up end cutaway view of a portion of the grate 100A of FIG. 5.

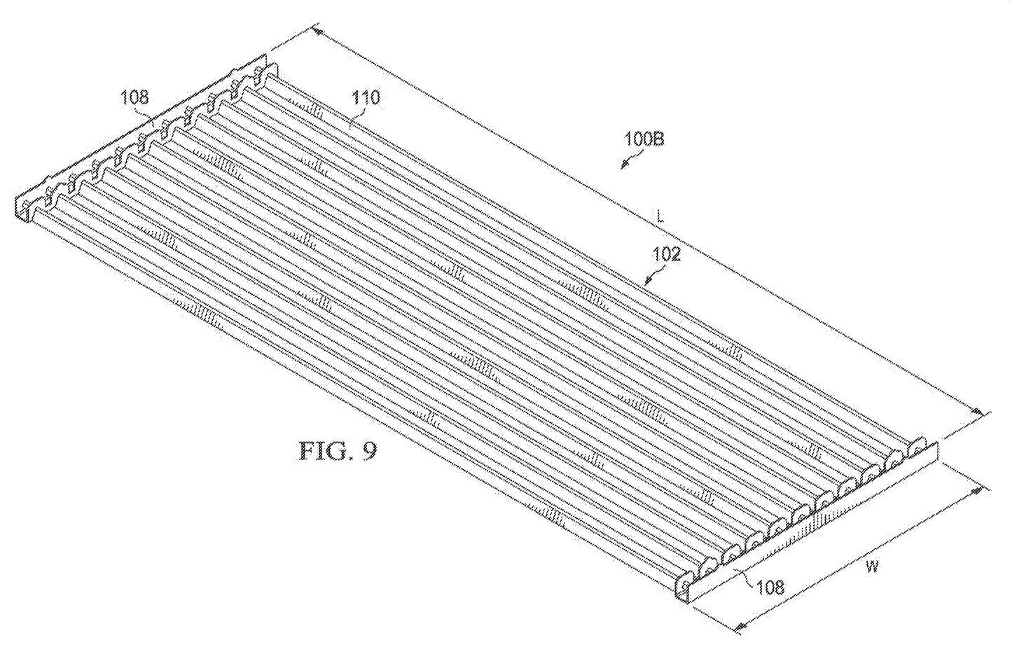

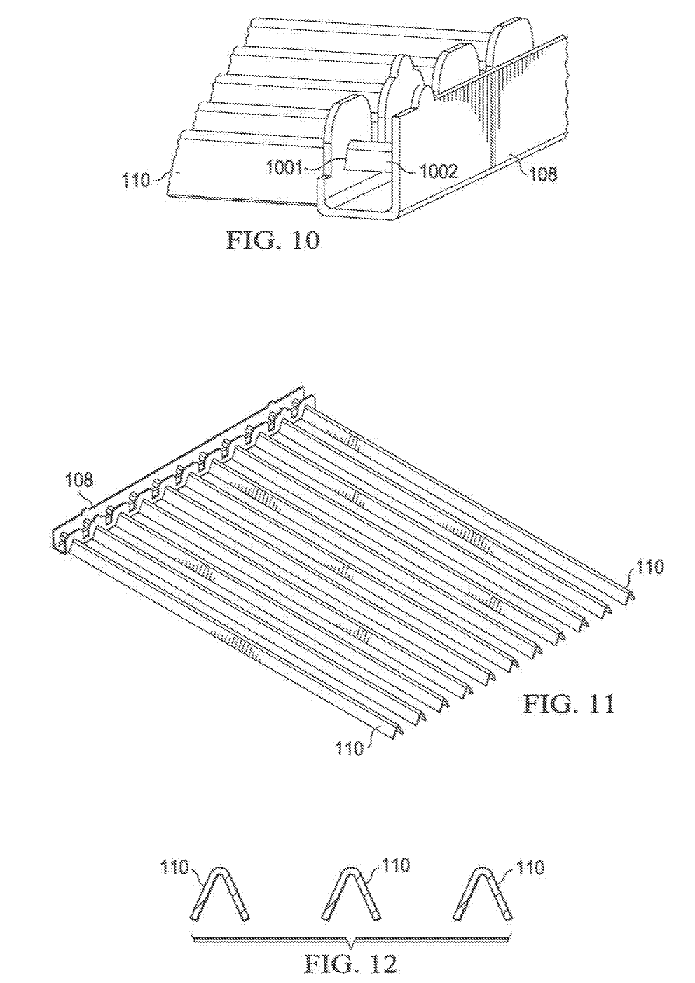

Referring now to FIG. 9, a perspective view of a lower cooking grate 100B of FIG. 1 is shown. The lower grate 100B cooperates with the upper grate 100A to form the complete integrated grate 100 with the full cooking surface 102. However, each of the sub-grates 100A and 100B can be utilized separately to alter cooking characteristics of the surface 102. FIG. 10 is a perspective side cutaway view of a portion of the lower cooking grate 100B of FIG. 9. FIG. 11 is a perspective end cutaway view of the lower cooking grate 100B of FIG. 9. FIG. 12 is a close-up end cutaway view of a portion of the lower cooking grate 100B of FIG. 9.

With reference to the aforedescribed figures, it will be appreciated that the multi-part cooking grate 100, comprises the upper sub-grate 100A (FIG. 5) and the lower sub-grate 100B (FIG. 9). From the perspective view of FIG. 1, it can be seen that the cooking surface 102 may substantially comprise various pluralities of V-shaped cooking members. The V-shaped cooking members are divided into a first set 106 and a second set 110. The V-shaped cooking members of the first set 106 are affixed in relation to one another by upper cross members 104. Together the V-shaped cooking members 106 and the cross members 104 comprise sub-grate 100A. The V-shaped cooking members of the second set 110 are affixed in relation to one another by lower cross members 108. Together the V-shaped cooking members 110 and the lower cross members 108 comprise lower sub-grate 100B.

FIG. 2 illustrates how the upper cross members 104 and the lower cross members 108 have a cooperatively fitting relationship such that when fitted together, the first set of V-shaped cooking members 106 interfits with the second set of V-shaped members 110. With additional reference to the cutaway views of FIGS. 3 and 4, it can be seen that relatively little space remains between the V-shaped cooking members 106 and 110 in such a configuration.

Returning again to FIG. 5, the cooking grate 100 has been disassembled into its constituent components. FIG. 5 illustrates an upper portion of the grate 100A. From this view it can be appreciated how the cross members 104 retain the V-shaped cooking members 106 in a fixed relationship relative to one another. With reference to FIGS. 7 and 8 and it can also be seen how a relatively large amount of space is provided between the adjacent V-shaped cooking members 106.

Referring again to FIG. 9, a lower portion of the cooking grate 100B is shown. Here it can be seen that the cross members 108 retain the second set of V-shaped cooking members 110 in a fixed relationship relative to one another. With reference to FIGS. 11 and 12, it can be seen how a relatively large amount of space is, once again, provided between the adjacent V-shaped cooking members 110.

Inset FIGS. 6 and 10 provide additional illustration of the relationship between the cross members 104 and V-shaped cooking members 106, and the cross members 108 and V-shaped members 110, respectively. In one embodiment, the cross members 104 are channelized members with cutouts 602 for receiving a portion 604 of each of the V-shaped cooking members 106 and retaining them in a fixed relationship. As can be seen from FIG. 6, the portion 604 within the cutout 602 may only be a portion of the entire end of the V-shaped cooking members 106. The cross members 104 may also provide a series of V-shaped cooperating recesses 610 on at least one side for interfitting with the cooking members 110 from sub-grating 100B.

The cooking members 106 may be made from a heat resistant material such as steel, stainless steel, porcelain coated steel, ceramic, ceramic coated metal, or some other suitable material. The cross members 104 may also comprise a heat resistant material. The cross members 104 may be welded to the cooking members 106, have a friction or interference fit, or be affixed in another heat resistant manner.

Returning to FIG. 10, it can be seen that the cross members 108 may also be channelized with one side having cutouts 1001 for receiving a portion 1002 of the respective lower cooking members 110 to form the lower sub-grating 100B. The portions 1002 may be retained in the cutouts 1001 by a friction fit, or may be welded or provided with another heat resistant fastener. As shown in FIG. 10, the portions 1001 of the members 110 fitting the cutouts may be cut from the full V-shaped cooking members 110 rather than comprising the full height and width of the members 110 at the ends.

FIG. 2, which illustrates the combined cooking grate 100, shows how the cross members 104 and 108 nest to prevent end-to-end movement (along length L) of the assembled sub-grating 100A with 100B. Here the lower cross member 108 nests within the upper cross member 104, but the converse could also be implemented. Side-to-side movement (along width W) is inhibited by the interlocking of the upper cooking members 106 beside the lower cooking members 110. As described, the lower cooking members 110 also cooperate and interfit with the recesses 610 on the upper cross members 104 of the upper sub-grate 100A.

In the illustrated embodiments, the cross members 104, 108 also serve as end caps such that the respective cooking members 106, 110 are held in a fixed relationship from the ends, thus allowing the cooking surface 2502 to be more or less continuous between opposite ends. However, in other embodiments, cross members may be placed medially rather than, or in addition to, being placed on the ends. In such cases, the cross members 2504, 2508 may have cutouts on both sides for passing at least a portion of the cooking members completely through.

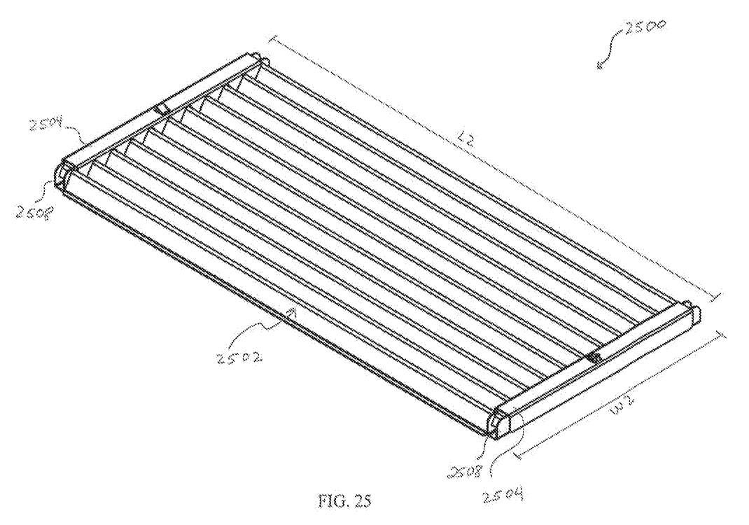

The cooking grate 2500 may be assembled as shown in FIG. 25 such that the combined V-shaped cooking members 2506 and 2510 provide for relatively little hot gas flow to the cooking surface 2502. Consequently, when configured as shown in FIG. 1, the cooking grate 2500 will provide a relatively larger amount of radiative heating. However, when either one of the upper or lower sub-grates 100A, 100B is used alone, it can be seen that a relatively large amount of hot gas will be allowed through the cooking surface 102. Consequently, in the configuration of FIG. 5 or 9, a relatively high amount of cooking by convection will occur compared to that of FIG. 1.

The cooking surface 102 may be easily and quickly reconfigured from that of FIG. 1 to that of FIG. 5 or 9 by a user without tools. In one embodiment, the space between adjacent V-shaped cooking members of the first set 106 may differ from the spacing between adjacent V-shaped members of the second set 110. This may be accomplished, for example, by varying the widths of the members of the first set 106 relative to the width of members of the second set 110, as shown in FIG. 24. In this way, the cooking grate 100A may provide different cooking characteristics than cooking grate 100B and each will be different than the combination 100 of FIG. 1. Thus, multiple cooking configurations with differing combinations of radiant and convective heating can be achieved with the same grate device. It should also be understood that the cooking members may not be V-shaped in all embodiments. To greater or lesser degrees, other cooking member shapes, such as round or rectilinear in cross-section, could function with some embodiments of devices of the present disclosure.

The general dimensions of the cooking surface 102 and the constituent components of the grate 100 can be varied according to the needs of the user such that existing gas, charcoal, electric, and other grills can be retrofitted to utilize devices of the present disclosure. In one embodiment the materials used for the construction of the cooking grate 100 is cast iron.

As described, cooking characteristics are influenced by whether the grate 100 is utilized in the combined form including sub-grate 100A combined with sub-grate 100B, or whether one of sub-grates 100A, 100B are used individually. A primary variation in cooking characteristics is in the degree of heating that occurs on the surface 102 as a result of radiative heating (e.g., infrared) versus convective heating.

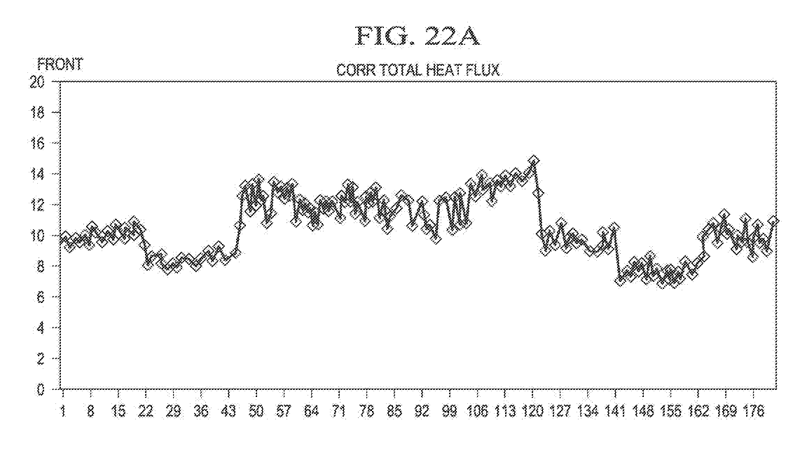

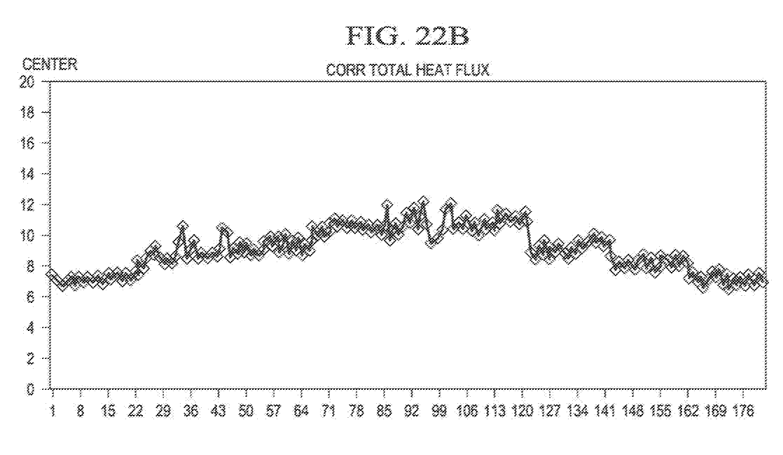

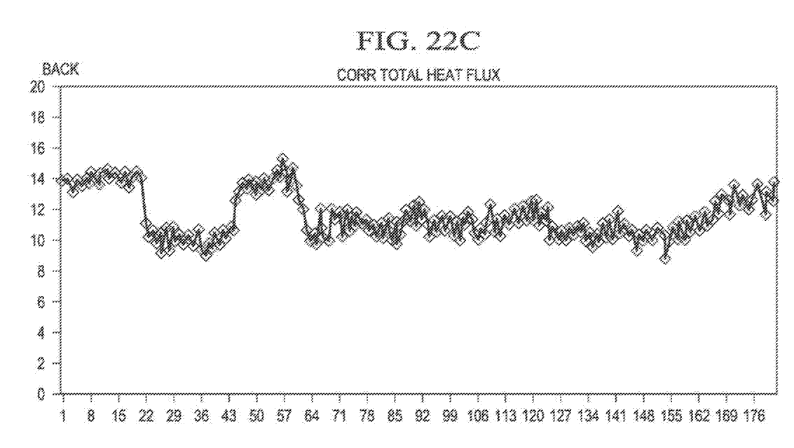

A grate was constructed according to that shown and described herein in FIGS. 1-12. Assembled as shown in FIG. 1, the grate was placed into the firebox of a gas grill with a 29,853 BTU/hour heat rate. The total cooking surface was 446.25 square inches. The heat input to the grate was 30.37205 kW/square meter. The heat flux, percentage of IR, thermal efficiency, and radiative efficiency was measured at the front, center, and back of the grill. The procedure used for measuring and calculating these values is described in a presentation summary entitled “Two New Methods for Measuring Performance of Underfired Broilers” by Alexander T. Gafford and presented to the American Society of Gas Engineers on Jun. 5, 2012 (currently available at www.asgenational.org/Content/Files/Presentations/2012/TwoNewMethodsMeasuringPerformance_AlexGifford.pdf), hereby incorporated by reference. The results of the test are summarized in Table 1 below. The corrected total heat flux at the front, center, and back are shown in the plots contained in FIGS. 22A, B, and C, respectively.

TABLE 1

| | heat flux | % IR | therm ef | rad ef |
|---|---|---|---|---|
| front | 10.45803 | 78.06689 | 34.43% | 26.78% |
| center | 9.215902 | 80.91794 | 30.34% | 24.58% |
| back | 11.77218 | 79.13757 | 38.76% | 30.75% |
| avg. | 10.48204 | 79.37413 | 0.345121 | 0.273682 |

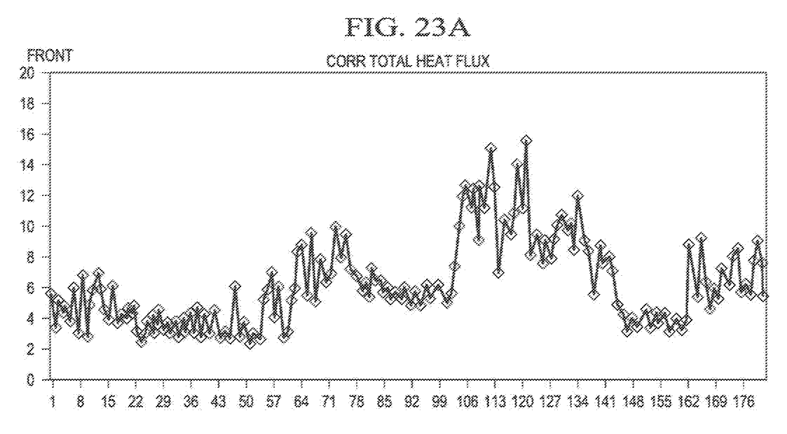

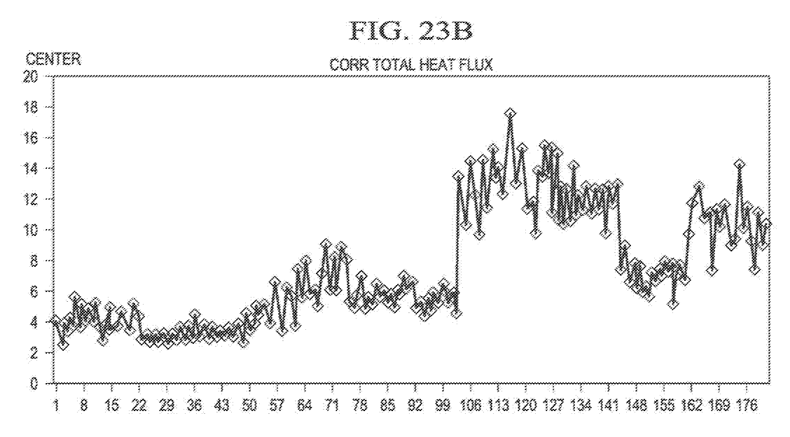

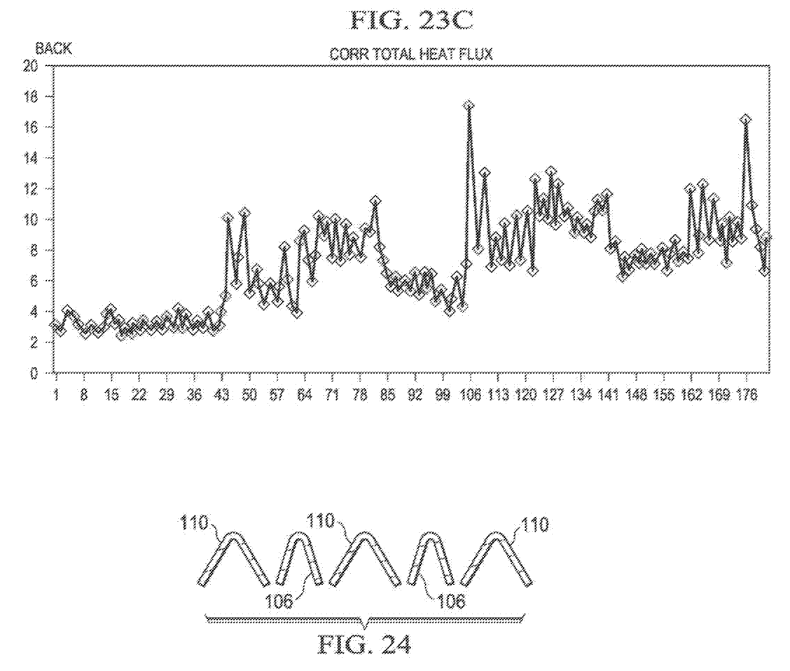

The portion of the tested grate corresponding to the bottom sub-grate 100B was also tested alone. As shown in FIGS. 9-13, this configuration has a cooking surface 102 that is approximately half, or slightly more, open to the heat source in the firebox. The test procedure and conditions were the same as the initial test with the results summarized in Table 2 below. The corrected heat flux at the front, center, and back of the grating are shown in the plots contained in FIGS. 23A, B, and C, respectively.

TABLE 2

| | heat flux | % IR | therm ef | rad ef |
|---|---|---|---|---|
| front | 6.269843 | 42.46003 | 20.64% | 8.61% |
| center | 7.524133 | 48.3062 | 24.77% | 11.46% |
| back | 7.035842 | 47.61502 | 23.17% | 10.10% |
| avg. | 6.943273 | 46.12708 | 0.228607 | 0.100549 |

The results from these two tests indicate that with only the sub-grate (e.g., 100B) the radiant heat was 46.13% and the convective heat was 53.87%. With the fully assembled configuration (e.g., 100) radiant heat was 79.37% and the convective heat was 20.63%. Since the grating 100 is not air tight, it would be expected that even in the configuration of FIG. 1, some convective heating would occur. However, the normally expected variation across cooking grates is +/−2%. The system of the present disclosure has demonstrated the ability to decrease (or increase) convective heating by a factor in excess of 2.5.

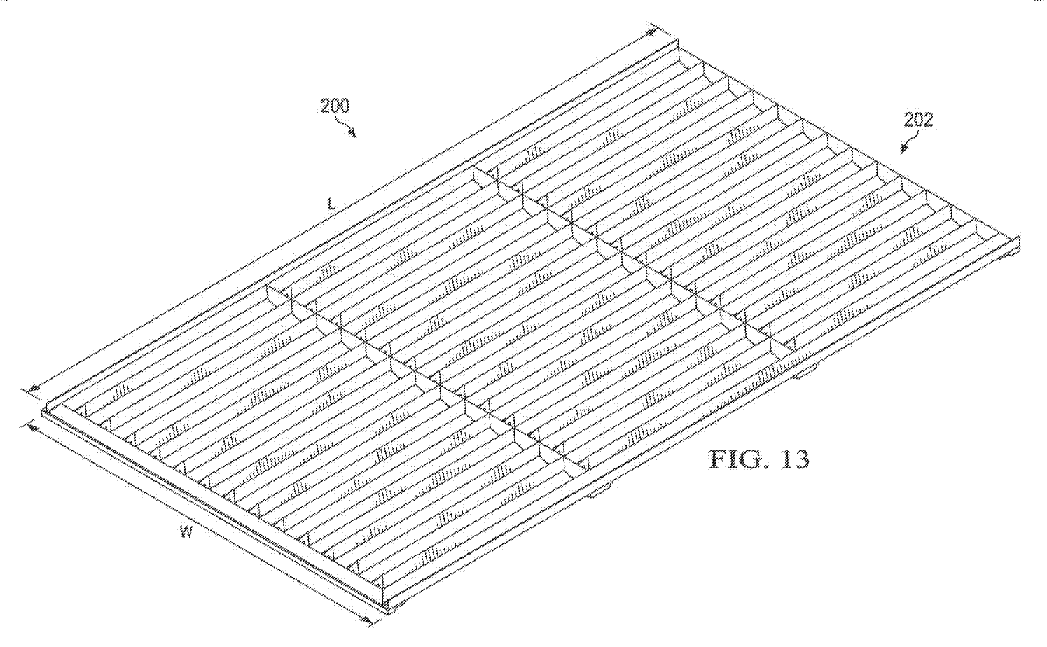

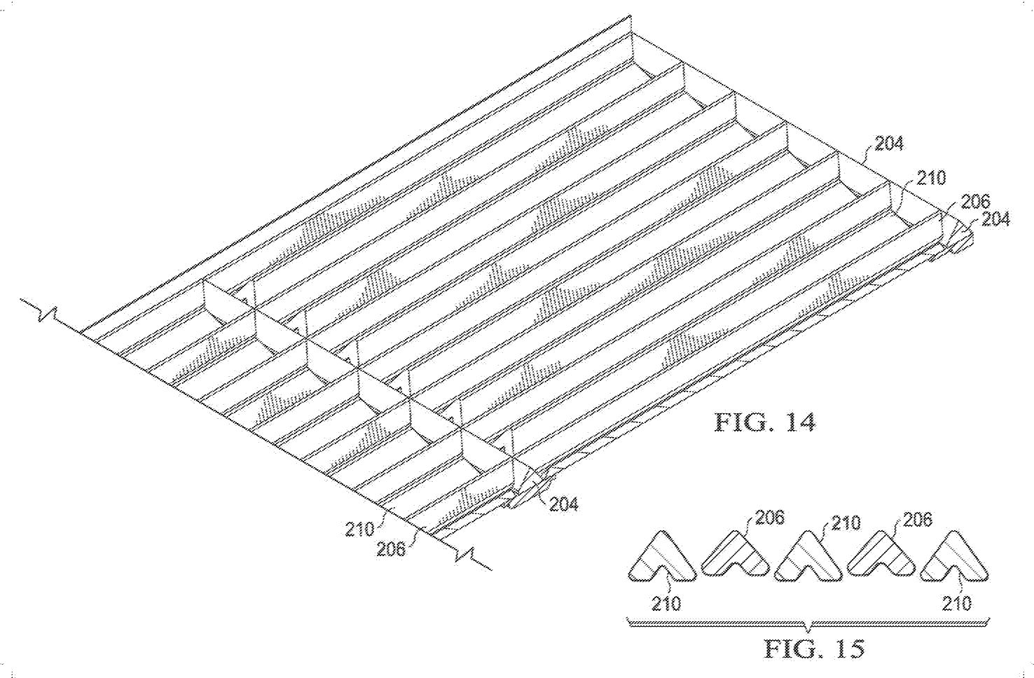

Referring now to FIGS. 13-21 another embodiment of a multi-component cooking grate 200 is shown. FIG. 13 is a perspective view of the grate 200 fully assembled in a radiative cooking mode. FIG. 14 is a perspective cutaway view of a portion of the cooking grate 200 of FIG. 13, and FIG. 15 is a close-up end cutaway view of a portion of the cooking grate 200 of FIG. 13.

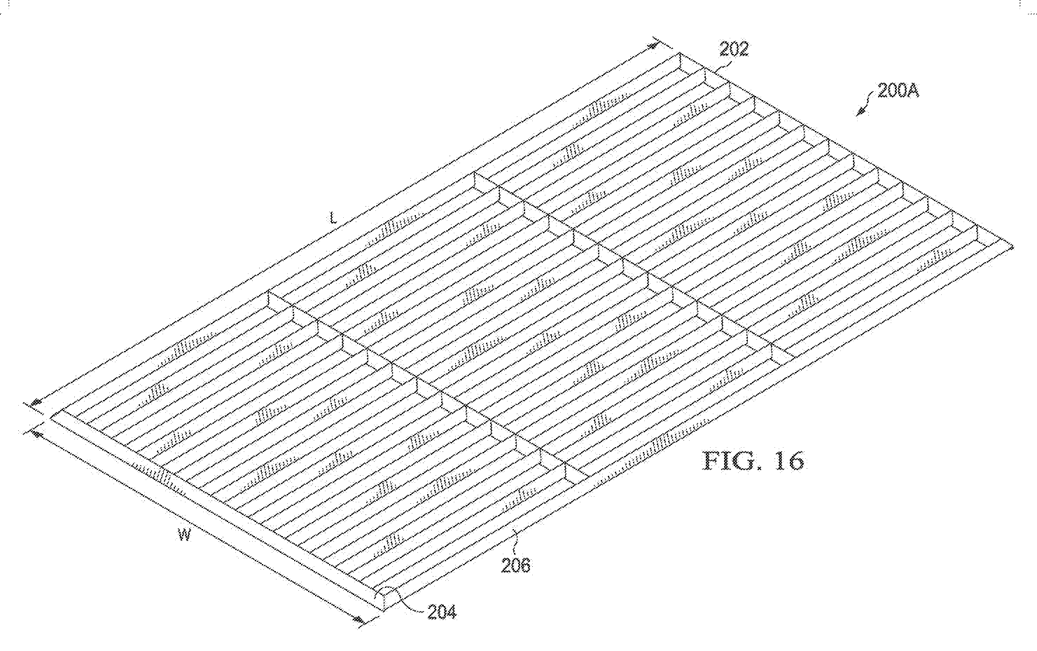

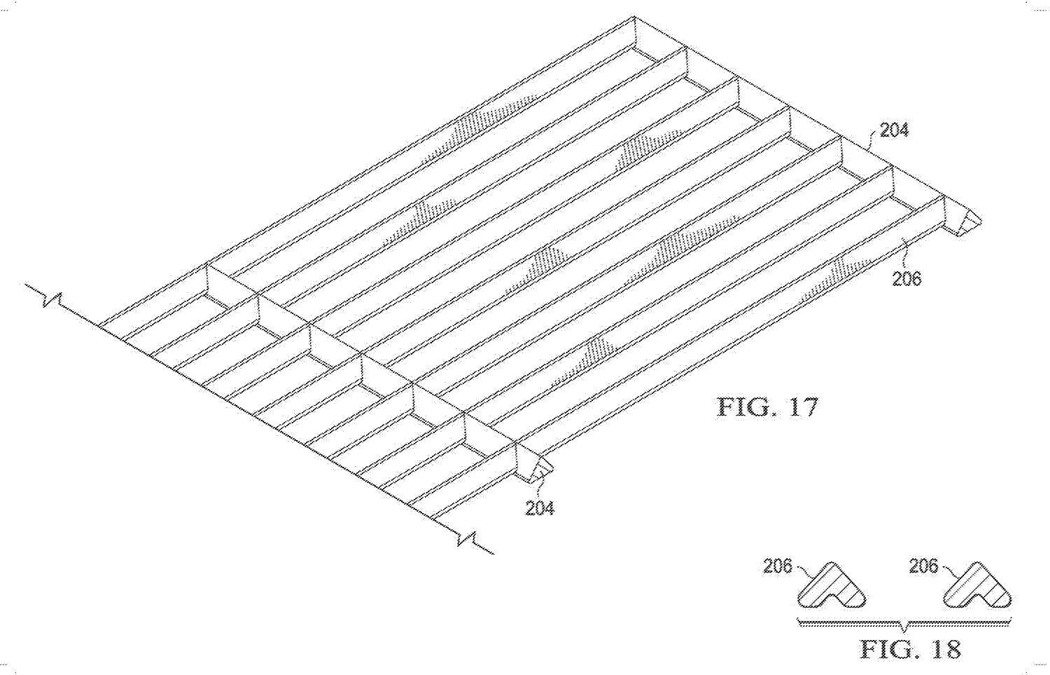

FIG. 16 is a perspective view of an upper portion 200A of the multi-part cooking grate 200 of FIG. 13. FIG. 17 is a perspective cutaway view of a portion of an upper cooking grate 200A of FIG. 16, and FIG. 18 is a close-up end cutaway view of a portion of the upper cooking grate 200A of FIG. 16.

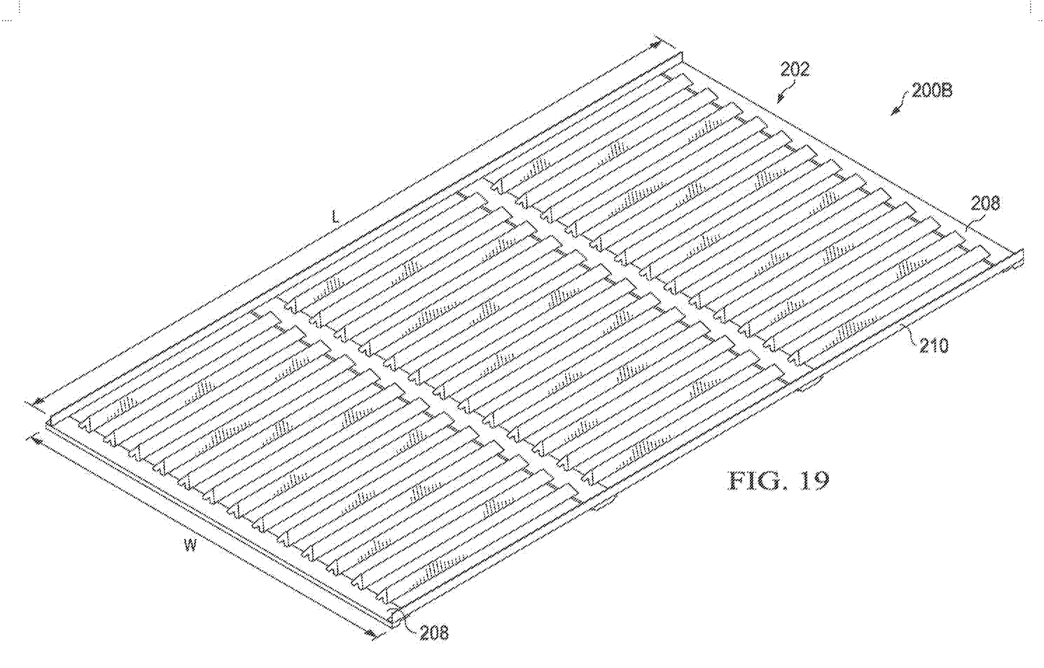

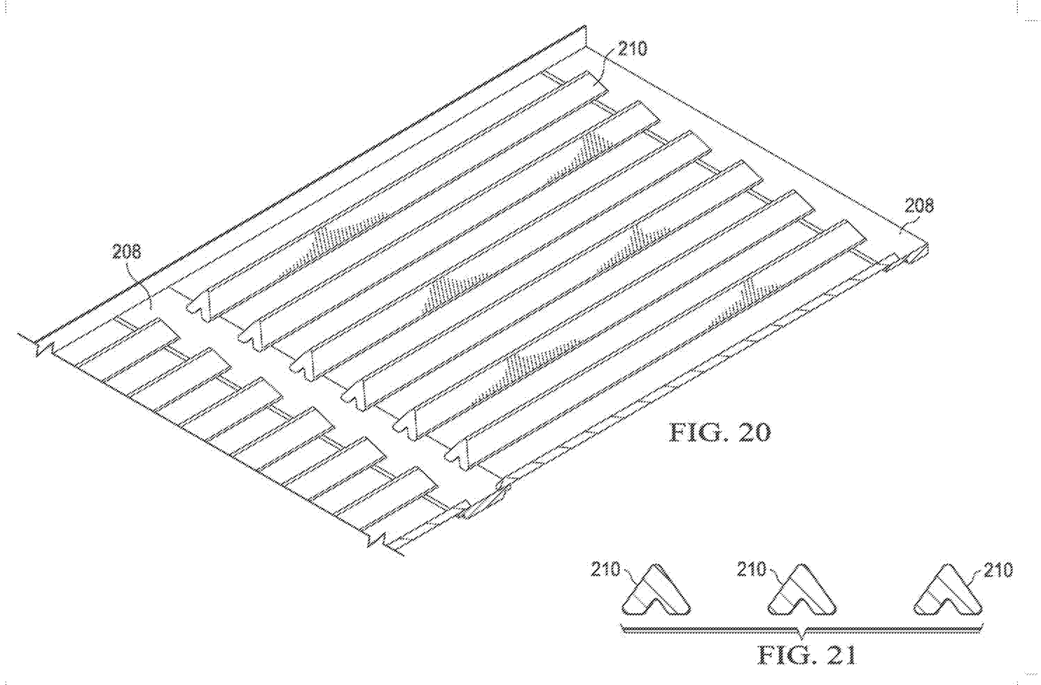

FIG. 19 is a perspective view of a lower portion 200B of the multi-part cooking grate 200 of FIG. 13. FIG. 20 is a perspective cutaway view of a portion of the lower cooking grate 200B of FIG. 19, and FIG. 21 is a close-up end cutaway view of a portion of the lower cooking grate of FIG. 19.

FIGS. 13-21 taken together fully illustrate another embodiment of a cooking grate 200 that is somewhat similar in function to the cooking grate 100 previously described. The cooking grate 200 comprises the upper grating 200A (FIG. 16) and the lower grating 200B (FIG. 19). From the inset view of FIG. 14, it can be seen how upper V-shaped cooking members 206 overlap with lower V-shaped cooking members 210. With reference to FIG. 15, it can be seen how relatively little air space is left between the V-shaped cooking members 206 and 210. Therefore, in the configuration shown in FIGS. 13, 14, and 15, a relatively large amount of heating of food on the cooking surface 202 will be by radiative heating.

With reference to FIGS. 16-18, the upper sub-grating 200A can be seen. FIGS. 17 and 18 particularly illustrate how a relatively large amount of air space remains between adjacent V-shaped cooking members 206. Thus, in the configuration of FIG. 16, a relatively large amount of heating will occur by convection. In the present embodiment, the V-shaped cooking members 206 are retained in a fixed relationship relative to one another by upper cross members 204.

Referring now to FIGS. 19-21, the lower sub-grating 200B can be seen. Similar to the upper sub-grating 200A, the lower sub-grating 200B connects V-shaped cooking members 210 in a fixed relationship relative to one another by lower cross members 208. As with the upper sub-grating 200A, the lower sub-grating 200B will provide for a relatively large amount of convective heating owing in part to the relatively large amount of air space between adjacent V-shaped cooking members 210.

As with previous embodiments, it can be seen that the cooking surface 202 may be configured as shown in FIG. 13, combining both of the upper sub-grate 200A and the lower sub-grate 200B to provide a cooking surface 202 that is heated substantially by radiative heating. In this configuration the lower sub-grate 200B, with its cooking members 210 interrupted along their length L, allows for the cross members 204 of upper sub-grating 200A to rest upon the cross members 208 of sub-grating 200B. Movement between the sub-gratings 200A, 200B along length L is prevented by the cross members 204 bearing against the interrupted cooking members 210. Movement along with width W is prevented by the adjacent cooking members 210 and 208 when assembled as shown in FIG. 13.

The upper sub-grating 200A and/or the lower sub-grating 200B can be used alone to provide a heating of surface 202 with a greater amount of convection heating relative to radiant heating as compared to the configuration of FIG. 13. As with previous embodiments, the spacing between the V-shaped members 206 and the V-shaped members 210 may not be the same. This may be accomplished, for example, by varying the size of the V-shaped cooking members 206 relative to the V-shaped cooking members 210. This allows the upper sub-grate 200A, the lower sub-grating 200B, and the combined grating 200 to each have different cooking characteristics. The upper sub-grating 200A and lower sub-grating 200B are user configurable. A user can vary the cooking characteristics of the cooking surface 202 by utilizing the combined grate 200 as shown in FIG. 13, or either of the sub-grates 200A, 200B.

The grate 200 may be made from cast or forged material, metal, or ceramic. In some embodiments, a coating (e.g., ceramic or porcelain) may be applied to all or a portion of the grate 200. As with previous embodiments, the dimensions of the cooking surface 202 are meant to be variable such that existing gas, charcoal, electric, or other grills can be retro-fitted to utilize the devices of the present disclosure. It is also understood that the various cooking members described herein may not be V-shaped in all embodiments. To greater or lesser degrees, other cooking member shapes, such as those that are round or rectilinear in cross-section, may function with the devices of the present disclosure.

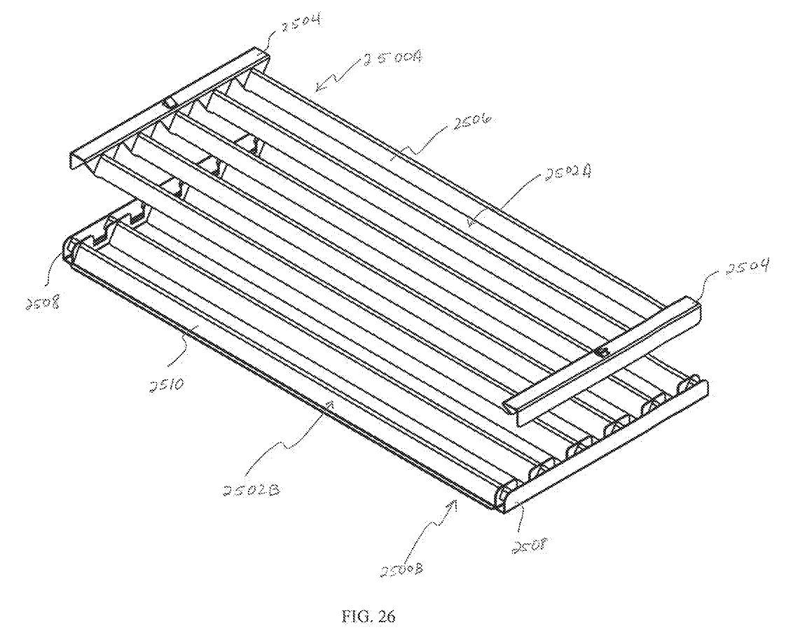

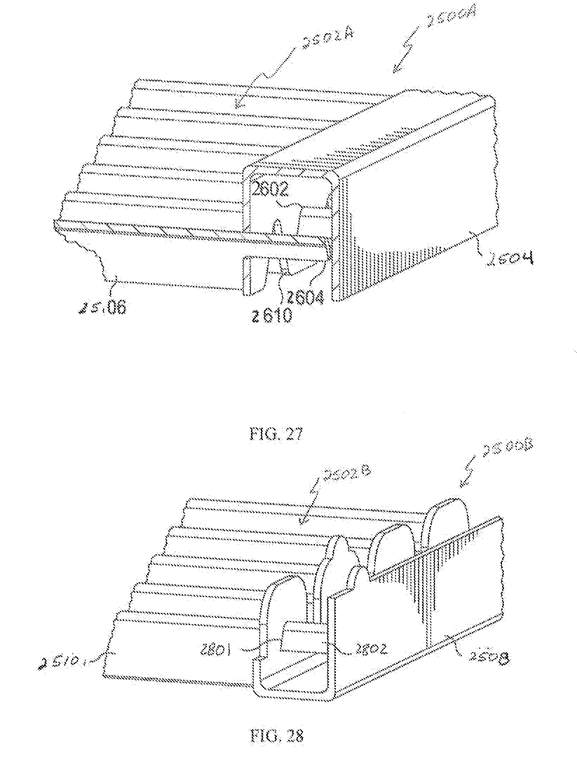

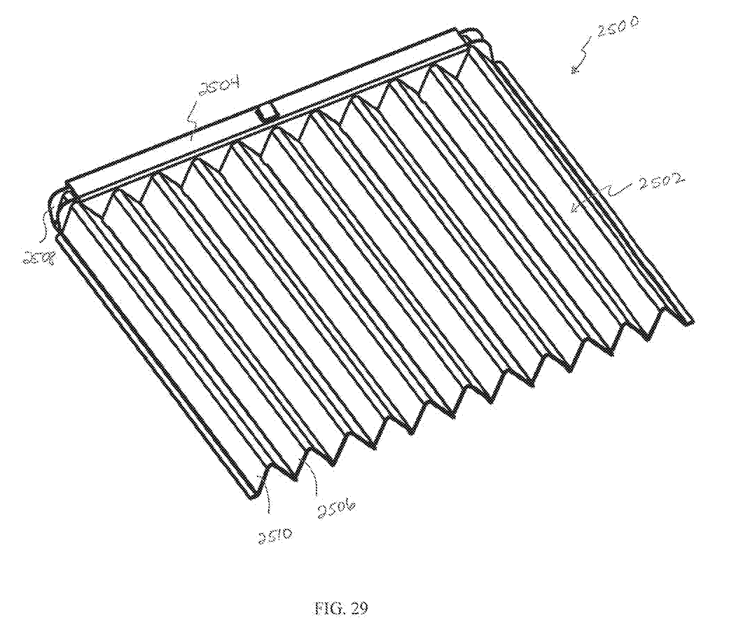

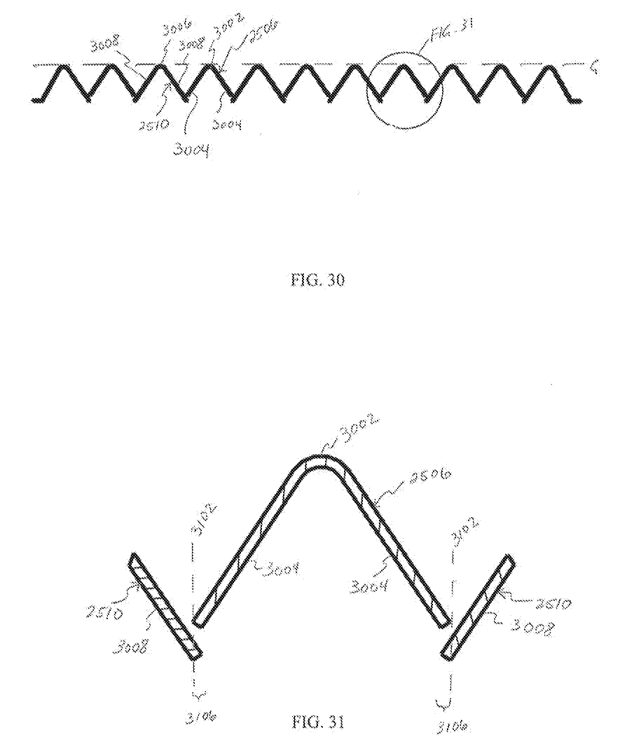

Referring now to FIGS. 25-30, another embodiment of a multi-part cooking grate 2500 according to aspects of the present disclosure is shown. FIG. 25 is a perspective view of the multi-part cooking grate 2500 while FIG. 26 is an exploded perspective view illustrating separated upper and lower cooking grates 2500A and 2500B, respectively. FIG. 27 is a perspective side cutaway view of an end portion of the upper cooking grate 2500A and FIG. 28 is a perspective cutaway view of an end portion of the lower cooking grate 2500B. FIG. 29 is a cutaway perspective view of the multi-part cooking grate 2500 while FIG. 30 is a cutaway end view of the same. FIG. 31 is a close up view of a portion of FIG. 30.

As with previous embodiments, the grate 2500 comprises a plurality of inverted V-shaped cooking members divided into two sets 2506, 2510. Although the cooking members 2506, 2510 may comprise shapes other than an inverted V, the relationship between the edges of adjacent cooking members 2506, 2510 is important in some embodiments, as explained below. Together the first set of cooking members 2506 and the end cross members 2504 comprise upper cooking grate or sub-grate 2500A. The second set of cooking members 2510 may be retained in a fixed relationship with respect to one another by end cross members 2508. Together the second set of cooking members 2510 and end cross members 2508 comprise lower cooking grate or sub-grate 2500B. In some embodiments, the cooking members within the sets 2506, 2510 are parallel to one another and the set of cooking members 2506 may be parallel to the set of cooking members 2510 when forming the grate 2500. As best seen in FIG. 26, the first set of cooking members 2506 may be retained in a fixed relationship with respect to one another by end cross members 2504.

The lower grate 2500A cooperates with the upper grate 2500B to form the complete grate 2500 forming the full cooking surface 2502. The set of cooking members 2506 is interleaved with the set of cooking members 2510 to form the cooking surface 2502. That is to say, in some embodiments, one of the cooking members 2510 will be flanked on either side by one of cooking members 2506 and vice versa (excepting outermost cooking members). Each of the sub-grates 2500A and 2500B may also be an integrated component and be utilized separately to alter cooking characteristics of the surface 2502 or form separate cooking surfaces 2502A, 2502B, respectively. By integrated component it is meant that the component is not intended to be further broken down or taken apart by a user, but will normally remain a single piece during use or even routine disassembly and cleaning activities.

FIGS. 27 and 28 provide additional illustration of the relationship between the cross members 2504 and V-shaped cooking members 2506, and the cross members 2508 and V-shaped members 2510, respectively. As shown in FIG. 27, the cross members 2504 may comprise channelized members with cutouts 2602 for receiving a portion 2604 of each of the V-shaped cooking members 2506 and retaining them in a fixed relationship. The portion 2604 within the cutout 2602 may only be a portion of the entire end of the V-shaped cooking members 2506. The cross members 2504 may also provide a series of V-shaped cooperating recesses 2610 on at least one side for interfitting with the cooking members 2510 from sub-grating 2500B.

As shown in FIG. 28, the cross members 2508 may also be channelized with one side having cutouts 2801 for receiving a portion 2802 of the respective lower cooking members 2510 to form the lower sub-grating 2500B. The portions 2802 may be retained in the cutouts 2801 by a friction fit, or may be welded or provided with another heat resistant fastener. The portions 2802 of the members 2510 fitting the cutouts 2801 may be cut from the full V-shaped cooking members 2510 rather than comprising the full height and width of the members 2510 at the ends.

The two sets of cooking members 2506, 2510 may be made from a heat resistant material such as steel, stainless steel, porcelain coated steel, ceramic, ceramic coated metal, or some other suitable material. The cross members 2504, 2508 may also comprise a heat resistant material. The cross members 2504, 2508 may be welded to the respective cooking members 2506, 2610, have a friction or interference fit, or be affixed in another heat resistant manner.

As best seen in FIG. 25, the cross members 2504 and 2508 nest when assembled into the full cooking grate 2500 to prevent end-to-end movement (along length L2) of the assembled cooking grate 2500. Here the lower cross member 2508 nests within the upper cross member 2504, but the converse could also be implemented. Side-to-side movement (along width W2) is inhibited by the interlocking of the upper cooking members 2506 beside the lower cooking members 2510B, the fitting of the lower cooking members 2510 into the recesses 2610 of the upper cross members 2504, and/or the partial fitting of the upper cooking members 2506 into the lower cross member 2508.

As illustrated, the cross members 2504, 2508 also serve as end caps such that the respective cooking members 2506, 2510 are held in a fixed relationship from the ends, thus allowing the cooking surface 2502 to be more or less continuous between opposite ends. However, in other embodiments, some cross members may be placed medially (not shown) rather than, or in addition to, being placed on the ends. Such medial cross members may have cutouts on both sides for passing at least a portion of the cooking members 2506, 2510 completely through.

As described to this point, the cooking grate 2500 bears some substantial similarities to the cooking grate 100 of FIGS. 1-12 previously discussed. However, some distinctions may be seen as well. These may be most readily appreciated from the illustrations of cooking grate 2500 provided in FIGS. 29-31 (a cutaway perspective view, a cutaway end view, and a close up view, respectively). The structure of the individual cooking members 2506, 2510 may be that of an inverted V. The cooking members 2506 of the upper grate 2500A have an apex or terminus 3002 representing the tops or highest points of each of cooking members 2506. Spaced apart legs 3004 descend downwardly and away from the apex 3002. The structure of the cooking members 2510 of the lower grate 2500B is similar in some respects. The cooking members 2510 provide an apex 3006 with a pair of spaced apart legs 3008 descending downwardly and away from apex 3006.

The respective apices 3002, 3006 are at approximately the same level “G” across the cooking surface 2502 when the upper sub-grate 2504 is fitted onto the lower sub-grate 2508. However, the lower legs 3004, 3008 of the respective cooking members 2506, 2510 of upper sub-grate 2504 and lower sub-grate 2508 may terminate at different lower points. As best seen in FIG. 31, the legs 3004 of cooking members 2506 may terminate above the legs 3008 of the cooking members 2510.

As the legs 3004 terminate at least slightly above the legs 3008, some lateral overlap may be provided when the sub-grate 2504 is assembled onto the sub-grate 2508. As best seen in FIG. 31, the overlap may be such that there is no straight vertical path from below the cooking grate 2500 to the top thereof. For illustration, vertical lines 3102 are provided at the outer edge of legs 3004 and these can be seen to pass through legs 3008. Correspondingly, if the vertical lines 3102 were to move to outer edges of legs 3008, they would pass through legs 3004. Thus, the legs 3008 may have both lateral and vertical overlap with the legs 3004. It should also be understood that the term “vertical” should be understood to mean substantially vertical. In one embodiment, a vertical line is blocked if the angle with respect to horizontal of a line drawn from anywhere on the horizontal plane (e.g., defined by the apices 3002, 3006) and passing through the grate assembly without touching either cooking members 2510 or 2506 is less than 90 degrees. In another embodiment, such vertical line is blocked if the angle with respect to horizontal is less than 80 degrees, 70 degrees, or 60 degrees.

One advantage of providing overlap such that there is no straight vertical pathway through the cooking surface 2502 of the fully assembled cooking grate 2500 is that of decreased burning or charring of food. Any flames or flare-ups from the heat source below (either from cooking fuel or ignition of grease or drippings) will encounter a crooked or tortured path through the cooking grate 2500. This will tend to substantially reduce or even eliminate contact between flame and food. Radiative heating from the cooking grate 2500 will remain unabated. Convection gases can also flow through the tortured pathway remaining between adjacent legs 3004, 3008 (though this may also be somewhat reduced from that seen through a straight path).

Exact spacing and positioning between legs 3004, 3008 may vary and yet achieve the effects described herein. In FIG. 31, it can be seen that the adjacent cooking members 2506, 2510 may not be in contact, yet the interruption of a vertical path from below the cooking members to above the cooking surface 2502 prevents flame from contacting food being cooked. Overlap 3106 between adjacent members 2506, 2510 can vary as well, but even a small degree of overlap (such that there is no clear vertical pathway) may prevent flare ups or contact between flame and food. Additionally manufacturing variations in the angle of form of the inverted V shape of cooking elements 2506, 2510, (e.g., as might be seen along the length of these elements as a waviness in the lower edges), can be more easily accommodated without losing effectiveness and ability to fit together compared to the embodiments as described and shown in FIG. 4

As with previous embodiments, the cooking grate 2500 may be assembled as shown in FIG. 25 such that the combined V-shaped cooking members 2506 and 2510 provide for relatively little hot gas flow to the cooking surface 2502. Consequently, when configured as shown in FIG. 25, the cooking grate 2500 will provide a relatively larger amount of radiative heating. When either one of the upper or lower sub-grates 2500A, 2500B is used alone, a relatively large amount of hot gas will be allowed through the cooking surface 2502. The cooking surface 2502 may be easily and quickly reconfigured to utilize either or both of the sub-grates 2500A, 2500B without tools. The multi-part construction of the cooking grate 2500 also allows easy cleaning of the cooking surface 2502 separated into the sub-grates 2500A, 2500B.

Space between adjacent V-shaped cooking members of the first set 2506 may be the same as the spacing between adjacent V-shaped members of the second set 2510, or this spacing may differ. A differing spacing between cooking members 2506 versus cooking members 2510 allows for different cooking characteristics when either sub-grate 2500A, 2500B is used alone. Different spacings between cooking members 2506 or between cooking members 2510 may be accomplished, for example, by varying the widths of the members 2506, 2510 themselves, or varying the degree of bend they contain (e.g., the angle of the apices 3002, 3006). It should be understood that the indirect or tortured flame path (e.g., no unimpeded vertical path through the cooking surface 2502) may not be present where either sub-grate 2500A, 2500B is used alone.

The cooking members 2500A, 2500B may not be V-shaped in all embodiments. To greater or lesser degrees, other cooking member shapes, such as round or rectilinear in cross-section, could function with some embodiments of devices of the present disclosure. However, in embodiments for which an indirect or tortured flame path is desired, shapes for the cooking members 2506, 2510 should be chosen that accommodate this while still allowing for easy assembly and disassembly of the cooking grate 2500 into sub-grates 2500A, 2500B.

The general dimensions of the cooking surface 2502 and the constituent components of the cooking grate 2500 can be varied according to the needs of the user such that existing gas, charcoal, electric, and other grills can be retrofitted to utilize devices of the present disclosure. In one embodiment, the materials used for the construction of the cooking grate 2500 is cast iron.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not to be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26 -100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooking grate comprising:
a first upper sub-grate having a first plurality of cooking members retained in a fixed relationship relative to one another by at least one upper cross-member; and
a second lower sub-grate having a second plurality of cooking members retained in a fixed relationship relative to one another by at least one lower cross member;
wherein the first and second sub-grates are configured to fit together such that their respective cooking members interfit to define a first cooking surface that heats with a relatively high degree of radiant heating relative to convective heating;
wherein the first and second sub-grate each define a second cooking surface that heats with a relatively low degree of radiant heating relative to convective heating; and
wherein the first and second sub-grate fit together such that only an indirect path remains from below the cooking surface to above the cooking surface such that flame is impeded from travelling below the cooking surface to above the cooking surface.

2. The cooking grate of claim 1, wherein the cooking members of the first and second sub-grates have an inverted V shape with vertices of the cooking members of the first and second sub-grates terminating and substantially the same level.

3. The cooking grate of claim 2, wherein the cooking members of one of the first and second sub-grates have legs that extend to terminate below the legs of cooking members of the other sub-grate.

4. The cooking grate of claim 3, wherein the cooking members of the first and second sub-grate overlap laterally.

5. The cooking grate of claim 4:
wherein the first sub-grate retains its associated cooking members at a first predetermined spacing from one another;
wherein the second sub-grate retains its associated cooking members at a second predetermined spacing from one another; and
wherein the first and second predetermined spacings are different so as to provide different degrees of heating between radiant and convective heating.

6. A cooking grate comprising:
two integrated sub-grates each having two end cross members maintaining a plurality of cooking members in a fixed relationship with respect to one another;
wherein the cross members on at least one end of each of the respective sub-grates nest to prevent end to end movement between the sub-grates; and
wherein the cooking members of one sub-grate interleaved with the cooking members of the other sub-grate forms a cooking surface operable to prevent contact between a cooking flame coming from below the cooking surface to food resting atop the cooking surface by blocking any straight vertical path through the cooking surface.

7. The cooking grate of claim 6, wherein the plurality of cooking members of each of the sub-grates comprise inverted V shapes with apices terminating at the same level to form the cooking surface.

8. The cooking grate of claim 7, wherein one of the sub-grates forms an upper sub-grate and the other sub-grate forms a lower sub-grate, and the cooking members of the lower sub-grate have legs that extend down from the apices below a level of legs extending from the apices of the cooking members of the upper sub-grate.

9. The cooking grate of claim 8, wherein the legs of the upper and lower sub-grates overlap laterally.

10. The cooking grate of claim 6, wherein each sub-grate has two cross members with one affixed at opposite ends of the plurality of cooking members.

11. The cooking grate of claim 10, wherein each sub-grate forms a separate cooking surface that may be used alone and each separate cooking surface provides a relatively higher degree of convective cooking energy than the cooking surface formed by the combined sub-grates.

12. The cooking grate of claim 11, wherein each sub-grate has a different lateral spacing between adjacent cooking members thereof than the other sub-grate.

13. A cooking grate comprising:
a first sub-grate formed from a first plurality of parallel cooking members held in a fixed relationship by a first cross member; and
a second sub-grate formed from a second plurality of parallel cooking members held in a fixed relationship by a second cross member;
wherein the first and second sub-grates combine to form a cooking surface that prevents flame from travelling therethrough to food on the cooking surface by blocking vertical pathways therethrough.

14. The cooking grate of claim 13, wherein the parallel cooking members of the first sub-grate have lateral overlap with cooking members of the second sub-grate.

15. The cooking grate of claim 14, wherein the cooking members of the first sub-grate have an inverted V shape.

16. The cooking grate of claim 15, wherein the cooking members of the second sub-grate have an inverted V-shape.

17. The cooking grate of claim 16, wherein the cooking members of the first sub-grate and the cooking members of the second sub-grate have apices at the same level but the cooking members of the second sub-grate have lower spaced apart legs that extend below lower spaced apart legs of the first sub-grate.

18. The cooking grate of claim 17, wherein the first and second cross members removably nest to prevent lengthwise movement between the first and second plurality of cooking members.

19. The cooking grate of claim 18, wherein the first and second sub-grates may each be used as a separate cooking surface that provides a pathway for flame from below to contact food on the separate cooking surfaces.

20. The cooking grate of claim 19, wherein each of the first and second sub-grates has an additional cross member and the two cross members for each of the first and second-sub grates form end caps to the respective parallel cooking members.
